(19) United States
(12) Patent Application Publication
(10) Pub. No.: US 2004/0161036 A1
(43) Pub. Date: Aug. 19, 2004

(54) MPEG encoding system

(76) Inventor: Satoru Yamauchi, Tsuchiura-Shi (JP)

Correspondence Address: TEXAS INSTRUMENTS INCORPORATED, P O BOX 655474, M/S 3999, DALLAS, TX, 75265

(21) Appl. No.: 10/366,218

(22) Filed: Feb. 13, 2003

(51) Int. Cl. H04N 7/12

(52) U.S. Cl. 375/240.16; 375/240.12; 375/240.24

(57) ABSTRACT

This invention provides a highly optimized compression algorithm that lessens the impact on picture quality when a small number of macroblocks—in a given frame—have a large motion vector. The invention controls the use of seldom-needed, large f-codes. This prevents the number of bits used to transmit the f-code from enlarging excessively. This invention discloses a method to compress the video signals efficiently, using an effective bit-allocation scheme to minimize f-code to provide high quality picture after detecting a motion vector.

### FIELD OF THE INVENTION

This invention is related to video compression using motion estimation, and more particularly to methods of decreasing the bandwidth required to code motion estimates.

### BACKGROUND AND SUMMARY

There are various MPEG standards used to encode video signals. One popular standard is known as MPEG-2. A typical MPEG-2 encoder system consists of elements A to M as shown in FIG. 1. A is a functional block to change picture processing order for the encoding. B is a motion estimation block to output a coded mode, a motion vector, and an f-code which shows an estimated range of a motion vector. C is a functional block to subtract a motion compensated signal from an original signal. D is a DCT (Discrete Cosine Transform) block. E is a Quantization block to quantize output signals from D, based on a bit-rate control value computed by a function of buffer fullness in J. F is a VLC (Variable Length Code) block to transform an output signal from E. G is an Inverse Quantization block to inverse-quantize the signal from E using the bit-rate control value. H is an IDCT (Inverse Discrete Cosine Transform) block. I is a multiplexer block to multiplex each output signal of B and F which is fed to J. At the same time, a motion vector and a coded mode are transformed into a variable length code in this block 1. J is a buffer to output bitstream constantly after temporarily storing the data from 1 into it. K is an adder to add an output signal of H and an output signal of M. L is a picture memory to store compressed signals. M is a motion compensation block to output the most suitable motion vector computed by compressed signals, the coded mode and the motion vector to provide a compensated high quality picture.

As a conventional encoder applies exactly the motion vector generated by B, the picture is not always compressed efficiently. One reason for this inefficiency is described here. When transforming a motion vector value of B in I into a VLC, the signal processing of (1), (2) and (3) will be done.

A f-code is set every frame to compress a picture, and provides an acceptable value of a motion vector.

For example, in case of a progressive MPEG-2 encoder:

If f-code=1, its acceptable range is −8 to +7.5 pixels.

If f-code=2, its acceptable range is −16 to +15.5 pixels.

If f-code=3, its acceptable range is −32 to +31.5 pixels.

If f-code=4, its acceptable range is −64 to +63.5 pixels.

If f-code=5, its acceptable range is −128 to +127.5 pixels.

If f-code=6, its acceptable range is −256 to +255.5 pixels.

If f-code=7, its acceptable range is −512 to +511.5 pixels.

(2) The differential value of a motion vector in B is computed, and a previous motion vector and a present motion vector are computed because of differential coded signal processing.

(3) A VLC is generated using the value computed by (2) and f-code. This VLC for the motion vector consists of a VLC of the motion vector and a fixed length code of the f-code. The transforming table of the motion vector is standardized. The fixed length code of the f-code is also standardized as well as the “f-code's” generation method. In MPEG-2, the f-code is coded as “the f-code minus 1”. For example, if f-code=3, its fixed coded value is 2 bits. But, if the motion vector value computed in (2) is zero, the fixed coded value for f-code is 0.

As a conventional encoder always uses all the motion vectors estimated in B, it determines f-code from the biggest one of the absolute values in the motion vectors of a frame. As the performance of the motion estimation in B advances and the range of the estimation becomes wide, the largest value of f-code will be selected, which typically makes more efficient compression possible. But, the wider motion estimation range doesn't always lead to the highest efficiency compressed coding. One example will be discussed as follows.

In case of a picture with 720 progressive scanning lines (which is called a 720P picture), the effective horizontal pixels are 1280, and the effective scanning lines are 720. The number of macroblock (16 pixels by 16 lines) per frame is 3600. Supposed that one of macroblocks is moving fast with its estimated motion vector of 128 pixels for a horizontal direction and 63 lines for a vertical direction, and also the motion vector for the other 3599 pixels is within the range of f-code=2, from the formula in (1) above, this frame has an f-code=6 for the horizontal motion vector and f-code=4 for the vertical one.

Therefore, from the formula in (2), the fixed length code for f-code are 5 bits per macroblock for a horizontal motion vector and 3 bits per macroblock for a vertical motion vector. So, a maximum of (5+3)*3600=28800 bits (A) are used as the fixed length code for the f-code.

If the encoder has only f-code=2 as the estimation range, it has 1 bit for a horizontal and 1 bit for a vertical as its fixed length code. So, maximum (1+1)*3600=7200 bits (B) are used as the fixed length code for the f-code.

The extra required coding amount generated by detecting the fast moving macroblock is (A) minus (B)=21600 bits (C). As a result—in this frame—the encoder with a narrow search range in B provides a better coding efficiency because it generates the lower encoded bit amount.

Though the above may seem to be an abnormal case, it could happen in several scenarios. For example, with a scene of a tennis court where the audience is watching a tennis match, a big motion vector is not generated by the seated audience. For the audience, small motion vectors will be generated because they are generally still. However, as the tennis ball moves very fast, a big motion vector will be generated. As there are the court and audience in this picture, the ball takes up a very small area—that is, it consists of a few macroblocks. Thus, this scenario exemplifies the calculations above. This shows that efficient compression is not always performed by making the motion estimation range wide. This tendency will be more emphasized as the number of macroblocks per frame increases—such as in the high resolution pictures of HDTV.

A method of MPEG encoding a video signal is disclosed. This method includes receiving a plurality of macroblock motion estimates, determining a plurality of f-codes, each f-code corresponding to one of the macroblock motion estimates, calculating a maximum f-code, the maximum f-code based on the distribution of f-codes in the plurality of f-codes, and for f-codes that exceed the maximum f-code, changing the corresponding macroblock motion estimate to zero. Typically, the video signal is an MPEG-2 video signal, and the macroblock motion estimates and the f-codes are multiplexed in with the compressed video for either transmission or storage. In one embodiment, the maximum f-code represents the largest f-code that is used by the slowest moving macroblocks, such as the slowest 98% or 99% of the macroblocks. Typically, the method uses the macroblock motion estimates—including the changed macroblock motion estimates—for motion compensation—such as providing motion compensated images within the MPEG encoder. In general this invention provides a method of motion vector evaluation during compression of a video signal, the method including receiving a plurality of sub-image motion estimates, the sub-image motion estimates including a speed; determining the distribution of speeds in the sub-image motion estimates; calculating a maximum usable speed, the maximum usable speed based on the distribution of speeds; and for motion estimates with speeds that exceed the maximum usable speed, changing the speed of the sub-image motion estimate to zero.

### DRAWING DESCRIPTION

FIG. 1 shows a conventional MPEG encoder block diagram.

FIG. 2 shows a block diagram of an embodiment of the MPEG encoder of the present invention.

FIG. 3 shows a block diagram of a motion vector evaluation implementation.

FIG. 4 shows a block diagram of an exemplary implementation of the P-0 block of FIG. 3.

FIG. 5 shows an example of the operation of the P-3 block of FIG. 4.

FIG. 6 shows an example of the operation of the P-3-2 block of FIG. 5.

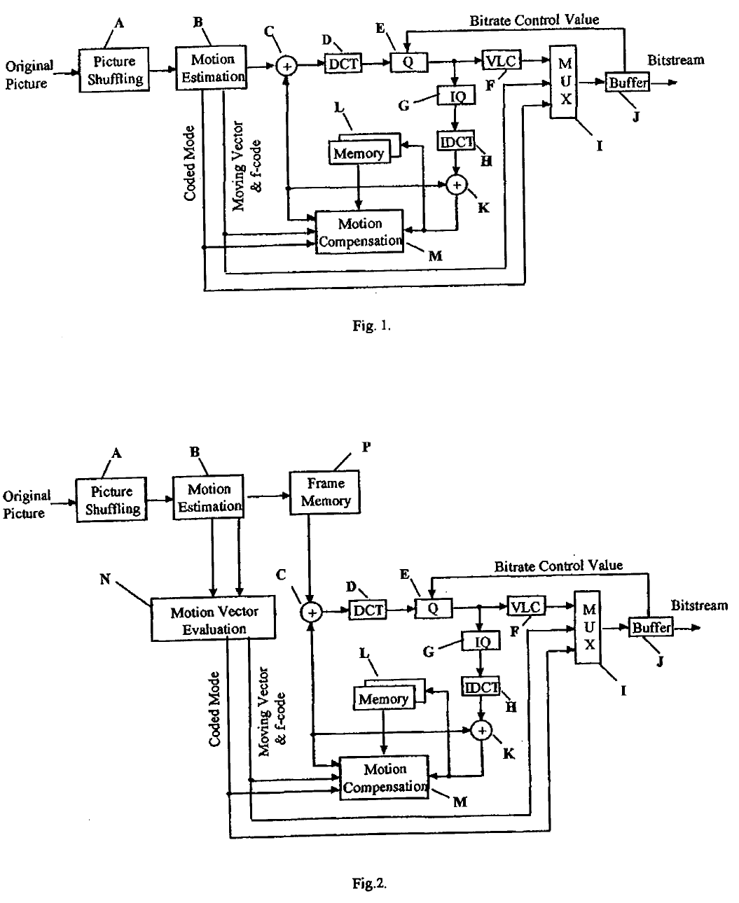

### DETAILED DESCRIPTION

One embodiment of this invention is shown in FIG. 2. In this invention, the functions shown are meant to be executed on one or more computing devices or integrated circuits—in conjunction with appropriate support elements. Some examples of devices that could be used to implement these functions include microprocessors, digital signal processors, special purpose processors, programmable logic devices, and application specific integrated circuits. These devices are typically integrated into systems of various types—such as cameras, recorders, terrestrial and satellite digital television systems, video compressors, or other video systems or devices. Skilled artisans will understand that while the details of the embodiment below teach the invention, many of the functions and subfunctions below can be implemented differently—either by a different software approach, or with hardware.

This new MPEG-2 encoding system consists of elements A to P. Functions A to M are same as those of a conventional encoding system. Motion vector evaluator N is a functional block to evaluate a motion vector from B and modify it if needed. Unless the delay through motion vector evaluator N can be nearly eliminated, a picture memory P will be needed to compensate for delays through motion vector evaluator N. P is a picture memory to delay picture data from B by one frame, and is located between B and C. The picture delay time in P corresponds to the delay time of a motion vector in N.

In this embodiment, the delay time shows one frame delay. We will discuss one method of how N can perform the motion vector evaluation. In N:

(1) N has 12 registers (6 in both horizontal and vertical directions) for the forward motion estimation and also 12 registers (6 in both horizontal and vertical directions) for the backward motion estimation in order to count the number of motion vector corresponding to two to seven of f-code, respectively.

(2) These register counters are reset to an appropriate value every frame.

(3) The f-code corresponding to a motion vector from B is checked one by one, and the corresponding register value is increased to count.

(4) At the end of a frame operation, the count value of each register is checked and N recognizes the distribution of motion vector values. So, N evaluates whether a very small number of macroblocks makes the f-code a large value or not.

(5) As the result of (4), the maximum f-code being used in the frame will be set based on the count value of the registers if N determines it is better not to use a large f-code.

(6) Then, the motion vector of each macroblock over the range of the maximum f-code will be forced to zero.

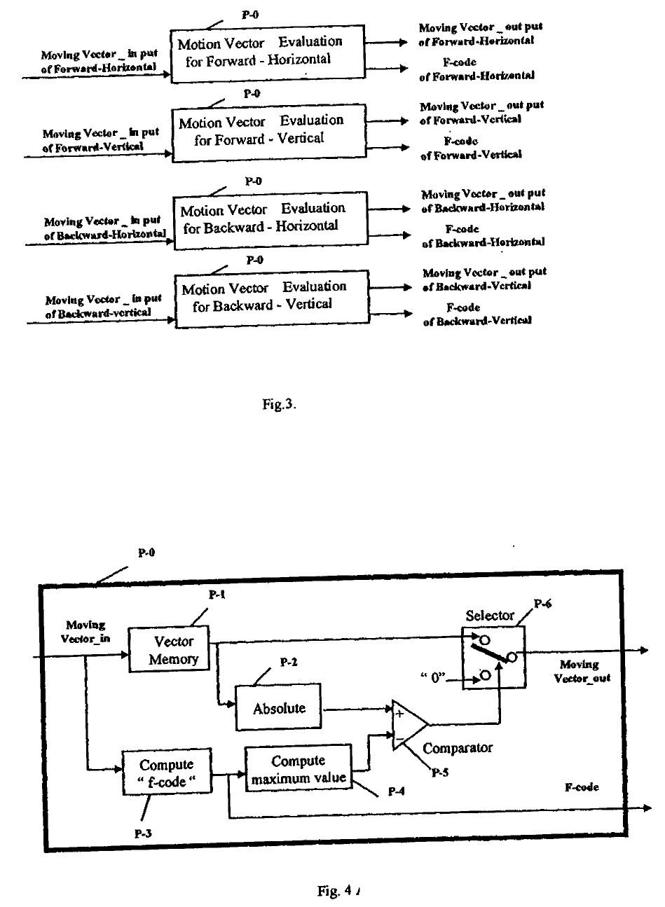

A functional block diagram of using N to evaluate a motion vector is shown in FIG. 3. There is no correlation for a motion vector between a forward motion estimation and a backward motion estimation, and also they are independent of each other. So, there are four P-0 blocks to evaluate the motion vectors. P-0 evaluates the input motion vectors and provides the most suitable f-code and the motion vector within the range of maximum f-code estimation every frame. In one embodiment, function P-0 consists of functions P-1, P-2, P-3, P-4, P-5, and P-6 as shown in FIG. 4.

P-1 is a memory to store motion vectors for a frame, and the stored data will be read out after one frame delay.

P-2 computes the absolute value of the data read out from P-1.

P-3 computes the most suitable maximum f-code based on the motion vectors from the input. After the f-code is computed from all the current frame's motion vectors, it may be output at the end of the current frame's operation.

P-4 estimates and sets the range of motion vectors corresponding to the f-code fed from P-3. For example, if f-code=1, the estimation range is −7.5 to +8 pixels. This value is as same as that of a conventional technology described in (1).

P-5 judges whether the data from P-3 are within the range set in P-4 or not. If so, the output signal is “High”.

P-6 selects the signal as same as the input signal if an output of P-5 is high, and the zero if an output of P-5 is low.

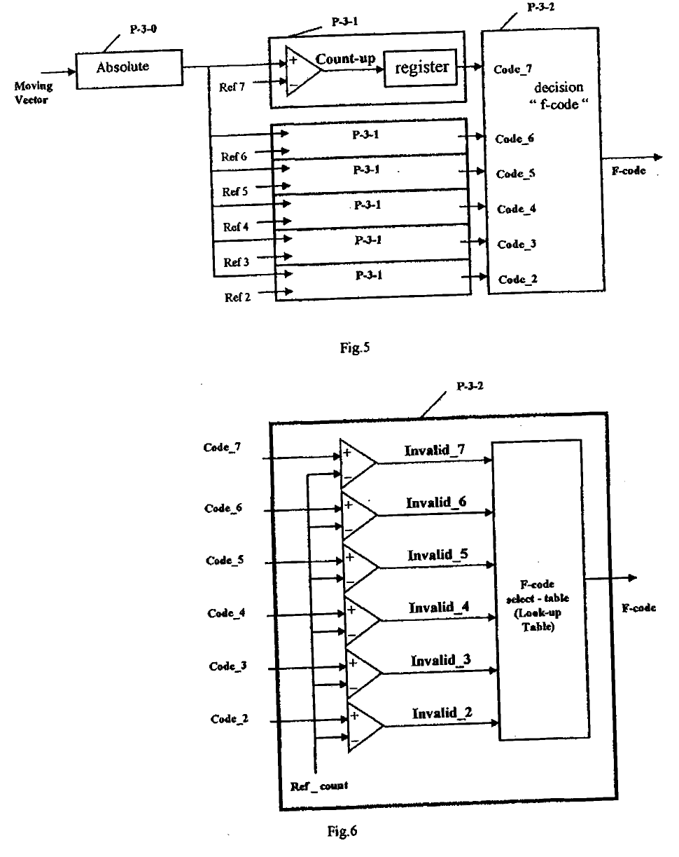

An exemplary version of the operation of P-3 will be discussed using FIG. 5, which shows its functional blocks. In this example, P-3 consists of P-3-0, six pieces of P-3-1, and P-3-2.

P-3-0 is a block to compute the absolute value of a motion vector.

P-3-1 contains a comparator and a register for up-counting. The comparator compares the absolute value of the motion vector (MV) from P-3-0 with the reference value (MVR). If MV is greater than MVR, the output signal of the comparator is “High”. If MV is smaller than MVR, the output signal of the comparator is “Low”.

After the count value of the register for up-counting is reset to zero every frame, the number of “Highs” from the comparator are counted and its number is output every frame. Six P-3-1's are required to correspond to 7, 6, 5, 4, 3 and 2 f-code. The reference values of is Ref7, Ref6, Ref5, Ref4, Ref3 and Ref2 as shown in FIG. 5. The reference value corresponding to f-code=7 is Ref7. Each reference value shows the value of a motion vector corresponding to each f-code, and its range will be as follows to detect a motion vector as explained in the conventional technology.

Ref7 is smaller than −256 or greater than +255.5 f-code=7

Ref6 is smaller than −128 or greater than +127.5 for f-code=6

Ref5 is smaller than −64 or greater than +63.5 for f-code=5

Ref4 is smaller than −32 or greater than +31.5 for f-code 4

Ref3 is smaller than −16 or greater than +15.5 for f-code=3

Ref2 is smaller than −8 or greater than +7.5 for f-code 2

P-3-2 will provide the most suitable f-code out of six data from P-3-1 and consists of six comparators and a lookup table to select the most suitable f-code based on the data from six comparators as shown in FIG. 6. The negative input of a comparator is connected to Ref_cont, and its comparator judges whether the output data from P-3-1 in FIG. 5 are greater than Ref_cont or not. One method of determining if a macroblock has an excessively large (invalid) motion vector is to not use f-codes that represent less than a certain percentage of the f-codes needed for a frame. A 1% floor has been shown to work well in many situations. However, different scenes or different frame sizes could result in smaller f-code floors—such as 0.5% or 0.8% of the f-codes needed for a frame—working better. In contrast, an even different scene or resolution could result in somewhat larger f-code floors—such as 1.5%, 2%, or even higher. Of course, setting this percentage too high, will—in effect—defeat the overall motion compensation scheme's ability to reduce bandwith requirements. In another way to look at this, the maximum f-code represents the largest f-code that is used by the slowest moving macroblocks—where the slowest moving macroblocks would be the slowest 99% of the macroblocks (for the 1% example). For this example, the number of macroblock (Ref_cont in FIG. 6) with a invalid large motion vector is limited to 1% of the total number of macroblock per frame. So, the number of Ref_cont is 3600*0.01=36 for a 750P picture format.

In the look-up table of FIG. 6, Invalid_{—}7 shows whether the number of macroblocks with a motion vector for f-code>=7 exceeds 36 or not. If so, Invalid_{—}7 will be “high”, and if not, it is “low”. It is defined as below:

Invalid_{—}7 to check the number of macroblock with f-code>=7

Invalid_{—}6 to check the number of macroblock with f-code>=6

Invalid_{—}5 to check the number of macroblock with f-code>=5

Invalid_{—}4 to check the number of macroblock with f-code>=4

Invalid_{—}3 to check the number of macroblock with f-code>=3

Invalid_{—}2 to check the number of macroblock with f-code>=2

Therefore, the greatest x (x=2˜7) in the Invalid with “high” will be selected as the most suitable f-code. For example, if Invalid_{—}7, Invalid_{—}6 and Invalid_{—}5 are low, and Invalid_{—}4, Invalid_{—}3 and Invalid_{—}2 are high, f-code will be 4. However, if all Invalid from 2 to 7 are low, f-code will be 1.

With this signal processing, the motion vector is corrected for the small number of macroblocks with a large motion vector, avoiding needlessly giving the system a large f-code. This reduction in the amount of bandwidth dedicated to the f-codes will free up bandwidth allocated to the compressed picture signal, thus providing an opportunity to realize a better picture quality.

This invention provides a highly optimized compression algorithm that lessens the impact on picture quality when a small number of macroblocks—in a given frame—have a large motion vector. The invention controls the use of seldom-needed, large f-codes. This prevents the number of bits used to encode the f-code from enlarging excessively. In the typical case where the transmit bandwidth is fixed, this smaller f-code encoding length will decrease the amount of video signal quantization required to fit the compressed image in the allowable transmit bandwith and in a smaller storage space.

I claim:

1. A method of MPEG encoding a video signal, the method including
receiving a plurality of macroblock motion estimates;
determining a plurality of f-codes, each f-code corresponding to one of the macroblock motion estimates;
calculating a maximum f-code, the maximum f-code based on the distribution of f-codes in the plurality of f-codes; and
for f-codes that exceed the maximum f-code, changing the corresponding macroblock motion estimate to zero.

2. The method of claim 1, wherein the video signal is an MPEG-2 video signal.

3. The method of claim 1, further including changing the f-codes corresponding to the changed macroblock motion estimates to zero.

4. The method of claim 3, further including transmitting the macroblock motion estimates and the f-codes.

5. The method of claim 3, further including storing the macroblock motion estimates and the f-codes.

6. The method of claim 1, wherein the maximum f-code represents the largest f-code that is used by the slowest moving macroblocks.

7. The method of claim 6, wherein the slowest moving macroblocks comprise the slowest 99% of the macroblocks.

8. The method of claim 6, wherein the slowest moving macroblocks comprise the slowest 98% of the macroblocks.

9. The method of claim 1, further including using the macroblock motion estimates—including the changed macroblock motion estimates—for motion compensation.

10. The method of claim 1, further including using the macroblock motion estimates—including the changed macroblock motion estimates—for providing motion compensated images within the MPEG encoder.

11. A method of encoding a video signal, the method including
receiving a plurality of block motion estimates;
determining a plurality of f-codes, each f-code corresponding to one of the block motion estimates;
setting a maximum f-code, the maximum f-code based on the distribution of f-codes in the plurality of f-codes; and
for f-codes that exceed the maximum f-code, setting the corresponding block motion estimate to zero.

12. The method of claim 11, wherein the video signal is an MPEG-2 video signal.

13. The method of claim 11, further including setting the f-codes corresponding to the changed macroblock motion estimates to zero.

14. The method of claim 11, further including using the macroblock motion estimates—including the changed macroblock motion estimates—for motion compensation.

15. The method of claim 11, further including using the macroblock motion estimates—including the changed macroblock motion estimates—for providing motion compensated images within the MPEG encoder.

16. The method of claim 11, wherein the maximum f-code represents the largest f-code that is used by the slowest moving macroblocks.

17. The method of claim 16, wherein the slowest moving macroblocks comprise the slowest 99% of the macroblocks.

18. The method of claim 16, wherein the slowest moving macroblocks comprise the slowest 98% of the macroblocks.

19. A method of motion vector evaluation during compression of a video signal, the method including
receiving a plurality of sub-image motion estimates, the sub-image motion estimates including a speed;
determining the distribution of speeds in the sub-image motion estimates;
calculating a maximum usable speed, the maximum usable speed based on the distribution of speeds; and
for motion estimates with speeds that exceed the maximum usable speed, changing the speed of the sub-image motion estimate to zero.
